(19) United States
(12) Patent Application Publication
(10) Pub. No.: US 2017/0034474 A1
(43) Pub. Date: Feb. 2, 2017

(54) VIDEO CONFERENCE TERMINAL

(71) Applicants: Tomoyuki GOTO, Kanagawa (JP); Hiroaki UCHIYAMA, Kanagawa (JP); Masato TAKAHASHI, Tokyo (JP); Koji KUWATA, Kanagawa (JP); Kazuki KITAZAWA, Kanagawa (JP); Nobumasa GINGAWA, Kanagawa (JP); Kiyoto IGARASHI, Kanagawa (JP)

(72) Inventors: Tomoyuki GOTO, Kanagawa (JP); Hiroaki UCHIYAMA, Kanagawa (JP); Masato TAKAHASHI, Tokyo (JP); Koji KUWATA, Kanagawa (JP); Kazuki KITAZAWA, Kanagawa (JP); Nobumasa GINGAWA, Kanagawa (JP); Kiyoto IGARASHI, Kanagawa (JP)

(73) Assignee: Ricoh Company, Ltd., Tokyo (JP)

(21) Appl. No.: 15/215,702

(22) Filed: Jul. 21, 2016

(30) Foreign Application Priority Data
Jul. 27, 2015 (JP) 2015-147682

(51) Int. Cl. H04N 7/14; G06F 3/16; H04N 7/15

(52) U.S. Cl. CPC H04N 7/147; H04N 7/152; G06F 3/16

(57) ABSTRACT

A video conference terminal includes a camera that captures a video image of a speaker, a microphone array that collects speech of the speaker, and a processor that executes a process. The process includes determining a direction of the speech, setting a sound collection range in which the microphone array collects the speech, the sound collection range including a predetermined range that covers the direction of the speech, and setting a view angle of the camera to match the sound collection range.

### CROSS-REFERENCE TO RELATED APPLICATIONS

The present application is based on and claims the benefit of priority Japanese Priority Application No. 2015-147682 filed on Jul. 27, 2015, with the Japanese Patent Office, the entire contents of which are hereby incorporated by reference.

### BACKGROUND OF THE INVENTION

1. Field of the Invention

The disclosure discussed herein relates to a video conference terminal.

2. Description of the Related Art

Conventionally, there is a video camera including multiple built-in microphones. The video camera includes an electrically-powered pan-tilt zooming function that enables a camera shot display range to be changed in vertical and horizontal directions according to control signals from outside the video camera.

The video camera with multiple built-in microphones includes amplifiers for amplifying signals output from each of the microphones and an A/D (Analog/Digital) converter for converting the signals amplified by each of the amplifiers into digital signals.

The video camera with built-in microphones also includes delay circuits for delaying the digital signals from the A/D converter. Each of the delay circuits corresponds to one of the multiple microphones. The video camera with built-in microphones also includes gain circuits for changing the gain coefficients of the signals output from the delay circuits.

The video camera with built-in microphones also includes adding circuits for adding the signals output from each of the gain circuits.

The delay time of each of the multiple delay circuits can be arbitrarily set within a predetermined range. By setting the delay time to a predetermined time according to the horizontal swing angle of the video camera, the shooting direction of the video camera and the orientation of the microphone can be moved in cooperation with each other (see, for example, Japanese Laid-Open Patent Publication No. H10-155107).

### SUMMARY OF THE INVENTION

According to an aspect of the disclosure discussed herein, there is provided a video conference terminal device that substantially obviates one or more of the problems caused by the limitations and disadvantages of the related art.

Features and advantages of the disclosure are set forth in the description which follows, and in part will become apparent from the description and the accompanying drawings, or may be learned by practice of the disclosure according to the teachings provided in the description. Objects as well as other features and advantages of the disclosure will be realized and attained by a video conference terminal device particularly pointed out in the specification in such full, clear, concise, and exact terms as to enable a person having ordinary skill in the art to practice the disclosure.

To achieve these and other advantages and in accordance with the purpose of the disclosure, as embodied and broadly described herein, the disclosure provides a video conference terminal includes a camera that captures a video image of a speaker, a microphone array that collects speech of the speaker, and a processor that executes a process. The process includes determining a direction of the speech, setting a sound collection range in which the microphone array collects the speech, the sound collection range including a predetermined range that covers the direction of the speech, and setting a view angle of the camera to match the sound collection range.

Other objects, features and advantages of the disclosure will become more apparent from the following detailed description when read in conjunction with the accompanying drawings.

### BRIEF DESCRIPTION OF THE DRAWINGS

FIG. 1 is a block diagram illustrating a hardware configuration of a video conference terminal according to an embodiment of the present disclosure;

FIG. 2 is a block diagram illustrating functional blocks included in a CPU according to an embodiment of the present disclosure;

FIG. 3 is a schematic diagram illustrating a coordinate system that includes a video conference terminal according to an embodiment of the present disclosure;

FIGS. 4A and 4B are schematic diagrams illustrating an operation of a video conference terminal according to an embodiment of the present disclosure;

FIGS. 5A and 5B are schematic diagrams illustrating an operation of a video conference terminal according to an embodiment of the present disclosure;

FIGS. 6A and 6B are schematic diagrams illustrating an operation of a video conference terminal according to an embodiment of the present disclosure;

FIGS. 7A and 7B are schematic diagrams illustrating an operation of a video conference terminal according to an embodiment of the present disclosure;

FIGS. 8A and 8B are schematic diagrams illustrating an operation of a video conference terminal according to an embodiment of the present disclosure;

FIGS. 9A and 9B are schematic diagrams illustrating an operation of a video conference terminal according to an embodiment of the present disclosure;

FIG. 10 is a schematic diagram illustrating an operation of a video conference terminal according to an embodiment of the present disclosure;

FIGS. 11A and 11B are schematic diagrams illustrating an operation of a video conference terminal according to an embodiment of the present disclosure; and

FIG. 12 is a flowchart illustrating an operation of a video conference terminal according to an embodiment of the present disclosure.

### DESCRIPTION OF THE EMBODIMENTS

Although the conventional video camera with built-in microphones can move the shooting direction of the video camera and the orientation of the microphone in cooperation with each other, the range in which the microphones collects sound is not matched with the angle of view of the video camera.

Therefore, not only is the voice of a speaker collected, but also unnecessary surrounding sounds are collected. This may lead to the difficulty in which the clarity of the audio-attached video image is reduced. This difficulty is significant particularly when the sound collecting range is wider than the angle of view of the video camera.

Next, a video conference terminal according to an embodiment(s) of the present disclosure is described.

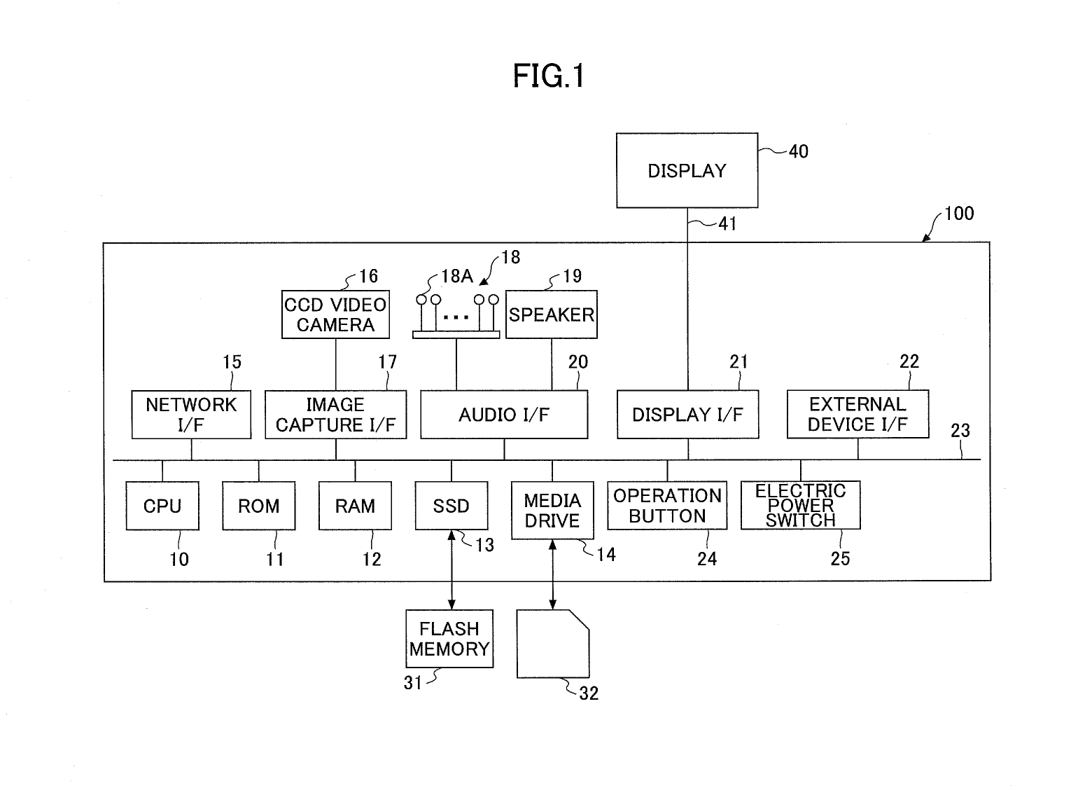

FIG. 1 is a block diagram illustrating a hardware configuration of a video conference terminal 100 according to an embodiment of the present disclosure.

The video conference terminal 100 includes a CPU (Central Processing Unit) 10, a ROM (Read Only Memory) 11, a RAM (Random Access Memory) 12, an SSD (Solid State Drive) 13, a media drive 14, and a network I/F 15.

The video conference terminal 100 also includes a CCD (Charge Coupled Device) video camera 16, an image capture I/F (interface) 17, a microphone array 18, a speaker 19, an audio I/F 20, a display I/F 21, an external device I/F 22, a bus line 23, an operation button 24, and an electric power switch 25. Further, a display 40 is connected to the video conference terminal 100.

The video conference terminal 100 is connected to one or more other similar video conference terminals via a communication network to form a video conference system. The multiple video conference terminals 100 included in the video conference system transmit image data and audio data between each other, so that participants situated apart from each other can hold a conference by way of audio-attached video images.

The CPU 10 is a control unit that controls the entire video conference terminal 100. The ROM 11 stores a program(s) executed by the CPU 10 to implement various functions of the video conference terminal 100.

The RAM 12 is used as a work space when the CPU 10 executes the program stored in the ROM 11. The flash memory 31 stores various data such as image data. The SSD 13 controls the writing of various data to the flash memory 31 and the reading out of various data from the flash memory 31 according to the controls of the CPU 10.

The media drive 14 controls the writing (storing) of data to the recording medium (e.g., flash memory) 32 and the reading out of data from the recording medium 32. The operation button 24 is operated in a case of, for example, selecting another video conference terminal 100 as a communication destination.

The electric power switch 25 is a switch that switches the electric power of the video conference terminal 100 on and off. The network I/F 15 connects the video conference terminal 100 to a communication network for enabling the video conference terminal 100 to transmit and receive data via the communication network. The communication network may be, for example, the Internet or a LAN (Local Area Network).

The CCD video camera 16 that is controlled by the CPU 10 is used as a video camera that captures video images. The CCD video camera 16 captures an object such as a participant of a video conference and obtains video image data. The CCD camera 16 is an example of an imaging unit.

In this example, a video camera having a wide-angle lens is used as the CCD video camera 16, so that multiple participants of the video conference can be viewed. The wide-angle lens is used so that an image of a wide range can be obtained.

Although an embodiment of the disclosure is described in the context of the CCD video camera 16, a video camera other than the CCD video camera may be used. For example, a video camera using CMOS (Complementary Metal Oxide Semiconductor) may be used instead of a CCD video camera.

The image capture I/F 17 controls the driving of the CCD video camera 16.

The microphone array 18 collects sound of a participant that is speaking (sound of participant). Further, the microphone array 18 includes multiple microphones 18A. Accordingly, the microphone array 18 detects the direction from which speech originates (arriving direction) based the time difference of the speech collected by the multiple microphones 18A. The arriving direction of speech refers to a direction in which the speech of a participant reaches the microphone array 18. That is, the arriving direction of speech indicates the direction of the location of the participant that has spoken (speaker) toward the microphone array 18.

The microphone array 18 has a function of detecting the speech of the participant by distinguishing between the speech of the participant and the sounds or noises other than the speech of the participant. The microphone array 18 associates speech data indicating the collected speech with direction data indicating the direction of the speech and outputs the associated data. The speech data and the direction data are input to the CPU 10.

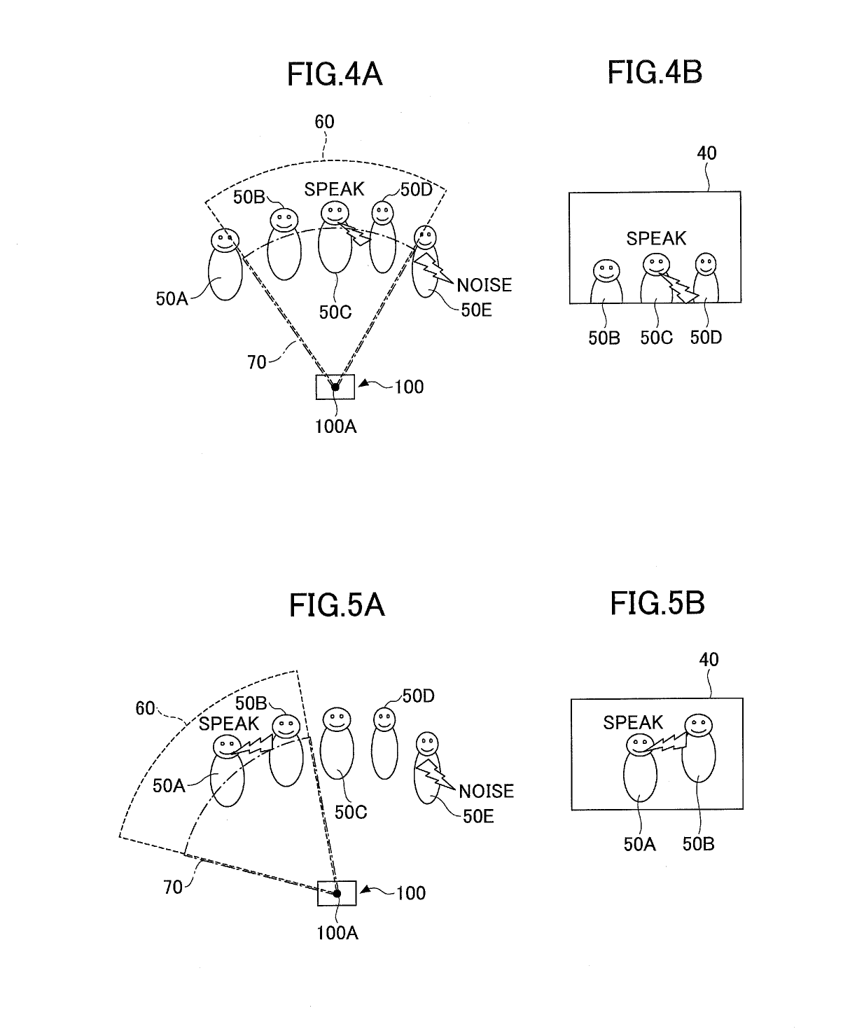

The microphone array 18 can change the range for collecting speech (sound collection range). The changing of the sound collection range is performed by the CPU 10. The microphone array 18 includes microphones that can change directivity (directivity direction). The CPU 10 changes the sound collection range of the microphone array 18 by controlling the directivity of the microphone array 18. The sound collection range is described below with reference to FIGS. 4A to 11.

The microphone array 18 is an example of a sound collecting unit. As long as the number of microphones 18A is two or more, the number of microphones may be set to a suitable number according to, for example, the usage of the video conference terminal 100 or the performance of the video conference terminal 100.

Although the microphone array 18 of this embodiment has a function of detecting speech by distinguishing between speech and noise, this function may be included in the CPU 10 instead of the microphone array 18.

The speaker 19 outputs sound indicating audio data transmitted from another video conference terminal 100.

The audio I/F 20 that is controlled by the CPU 10 performs a process of inputting the speech (audio) received by the microphone array 18 and a process of outputting audio from the speaker 19. Audio processes, such as the inputting process and the outputting process, may include, for example, a process of removing noise, a process of converting an analog signal into digital data, or a process of converting digital data into an analog signal.

The display I/F 21 that is controlled by the CPU 10 transmits video image data to the display 40. The external device I/F transmits and receives various data with respect to an external device connected to the video conference terminal 100.

The bus line 23 may be an address bus or a data bus that electrically connects the above-described hardware. In this embodiment, the address bus is a bus used for transmitting a physical address of a location in which data desired to be accessed is stored. The data bus is a bus used for transmitting data.

The display 40 and the display I/F 21 are connected to each other by way of a cable 41. The cable 41 may be, for example, a cable used for analog RGB (VGA) signals or component video. Further, the cable 41 may be a HDMI (High Definition Multimedia Interface, registered trademark) cable or a DVI (Digital Video Interactive) cable.

The external device may be an external input device such as a keyboard or a mouse. Further, the external device may also be an external camera, an external microphone, or an external speaker. The external device can be connected to the external device I/F 22 via a USB (Universal Serial Bus) connector.

The recording medium 32 may be a recording medium that is detachably attached to the media drive 14. The recording medium 32 allows data to be read therefrom and data to be recorded thereto. The recording medium 32 may be, for example, a CD-RW (Compact Disk ReWritable), a DVD (Digital Versatile Disk)-RW, or an SD (Secure Digital) card.

Other non-volatile memories of formats besides the flash memory 31 may also be used for reading data therefrom or writing data thereto. For example, the non-volatile memory may be an EEPROM (Electrically Erasable and Programmable ROM).

In this embodiment, the program that implements the various functions of the video conference terminal 100 is stored in the ROM 11.

Alternatively, the program may be recorded in the recording medium 32 in a file format that can be installed and executed by the video conference device 100.

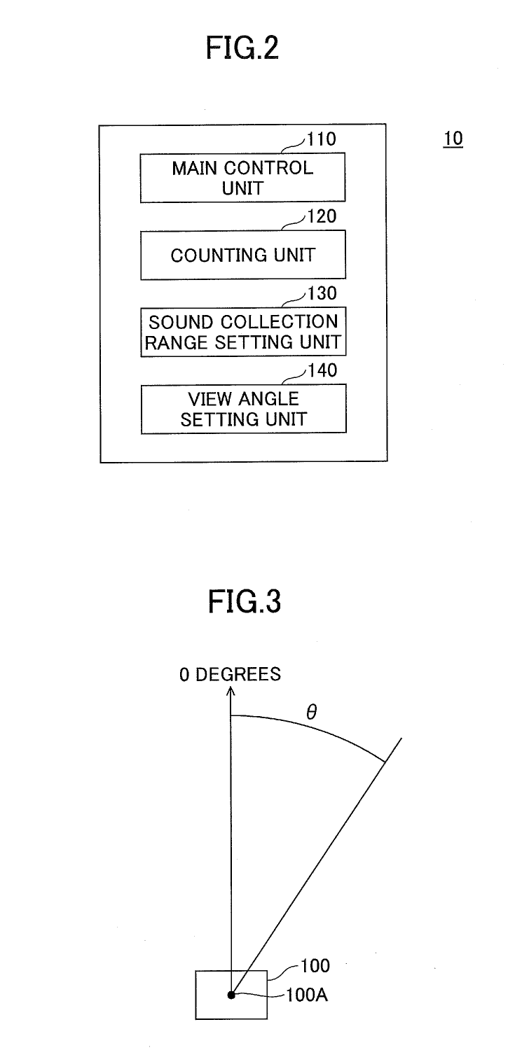

FIG. 2 is a block diagram illustrating functional blocks included in the CPU 10.

The CPU 10 includes a main control unit 110, a counting unit 120, a sound collection range setting unit 130, and a view angle (angle of view) setting unit 140.

The main control unit 110 has overall control of the various functions of the video conference terminal 100. The main control unit 110 identifies the direction of the participant that has spoken (speech direction) according to the direction data output from the microphone array 18. The direction data is associated with the speech data of the participant who has spoken.

The speech direction is determined based on a direction relative to the video conference terminal 100 inside a coordinate system including the video conference terminal 100. The coordinate system is described in further detail below with reference to FIG. 3.

The counting unit 120 counts the number of speech directions identified by the main control unit 120. Further, the counting unit 120 determines whether the number of speech directions is a single direction or multiple (two or more) directions. The sound collection range setting unit 130 sets the range that the microphone array 18 collects. The sound collection range setting unit 130 sets the range based on the speech direction identified by the main control unit 110 and the number of speech directions identified by the counting unit 120.

For example, in a case where the number of speech directions identified by the counting unit 120 is one, the sound collection range setting unit 130 sets the sound collection range of the microphone array 18 in the speech direction identified by the main control unit 110.

More specifically, in a case where the number of speech directions identified by the counting unit 120 is one, the sound collection range setting unit 130 sets the sound collection range to be a range covering a single person in the speech direction identified by the main control unit 110.

Further, in a case where the number of speech directions identified by the counting unit 120 is multiple directions, the sound collection range setting unit 130 sets the sound collection range of the microphone array 18 to be a range including the multiple speech directions identified by the counting unit 120.

More specifically, in a case where the number of speech directions identified by the counting unit 120 is multiple directions, the sound collection range setting unit 130 sets the sound collection range to be a range covering the multiple speech directions identified by the main control unit 110. In this case, the sound collection range covering the multiple speech directions is broader than the sound collection range for covering a single person.

The view angle setting unit 140 sets the angle of view of the video image shot by the CCD video camera 16 to match the sound collection range set by the sound collection range setting unit 130.

The view angle setting unit 140 sets the range of the image to be displayed on the display 40 (see FIG. 1) of another video conference terminal 100 by cutting out (extracting) a part of a video image shot by the CCD video camera 16.

Thus, in this embodiment, the view angle (angle of view) is not a range that can be shot by the CCD video camera but is a range for a part to be cut out (extracted) from a video image that can be shot with the CCD video camera 16.

For example, in a case where the number of speech directions counted by the counting unit 120 is one direction and the sound collection range of the microphone array 18 is set to a sound collection range for covering a single person, the view angle setting unit 140 sets the view angle for capturing the video image to be a view angle for a single person.

Further, in a case where the number of speech directions counted by the counting unit 120 is multiple directions and the sound collection range of the microphone array 18 is a range including multiple speech directions, the view angle setting unit 140 sets the view angle for capturing the video image to match the sound collecting range that covers the multiple speech directions.

Further, in a case where the number of speech directions identified by the counting unit 120 is multiple directions, the positional relationships between speaking participants could be various patterns. Therefore, the view angle setting unit 140 sets the view angle for capturing a video image by using various methods depending on the positional relationships of the multiple speech directions. The methods for setting the view angle are described below with reference to FIG. 4A to FIG. 11. Note that, although a part of a video image is cut out (extracted) to be the range of the view angle in the above-described embodiment, the view angle may be a range that can be shot by the CCD video camera 16. In this case, the view angle may be set by changing the range that can be shot by the CCD video camera 16.

FIG. 3 is a schematic diagram illustrating a coordinate system that includes the video conference terminal 100.

In the coordinate system including the video conference terminal 100 of FIG. 3, the video conference terminal 100 is depicted in a plan view state. Further, an arrow extending from a reference point 100A is assumed to be a predetermined direction that is 0 degrees. Further, assuming that the clockwise direction is a positive direction, “0” represents the angle relative to the predetermined direction.

The plan view state of the video conference terminal 100 refers to the video conference terminal 100 being viewed from an upper vertical direction (overhead view) in a state where the video conference terminal 100 is placed on a horizontal plane. Further, the reference point 100A is the center of the video conference terminal 100. Further, the predetermined direction is a certain fixed direction relative to the video conference terminal 100.

Note that the reference point 100A is not limited to the center of the video conference terminal 100 and may be another location. Further, the predetermined direction may be any direction as long as the direction is a fixed direction extending from the video conference terminal 100.

In the video conference terminal 100, the speaking direction is defined by the angle in the coordinate system illustrated in FIG. 3. In one example, the minimum value of the sound collection range of the microphone array 18 is 20 degrees whereas the maximum value of the sound collection range of the microphone array 18 is 360 degrees. Further, the sound collection range for a single person may be, for example, 20 degrees. Further, the view angle (angle of view) of the video conference terminal 100 is defined by the angle in the coordinate system illustrated in FIG. 3.

FIGS. 4A to 11 are schematic diagram illustrating the operations of the video conference terminal 100 according to an embodiment of the present disclosure.

As illustrated in FIG. 4A, the video conference terminal 100 is used by participants 50A, 50B, 50C, 50D, and 50E (hereinafter also simply referred to as “50A to 50E”). The participants 50A to 50E are facing toward the CCD video camera 16 and sitting in front of the video conference terminal 100.

Among the participants 50A to 50E, only the participant 50C is speaking. Further, noise is being created at the side of the participant 50E.

In the state illustrated in FIG. 4A, the video conference terminal 100 sets the sound collection range 60 to a range including the participant 50C who is speaking. Further, the video conference terminal 100 matches the view angle 70 with the sound collection range 60. Note that the noise created at the side of the participant 50E does not affect the setting of the sound collection range 60 because the microphone array 18 can distinguish the noise from the speech of the participant 50C.

Therefore, as illustrated in FIG. 4B, the participants 50B, 50C, and 50D having the speaking participant 50C in the middle are included in the video image extracted by the CCD video camera 16. The video image of FIG. 4B is displayed in the display 40 of each of the other video conference terminals 100 communicating with the video conference terminal 100 of FIG. 4A.

Because the range including the speaking participant 50C is set to be the sound collection range 60 and the view angle 70 is matched with the sound collection range 60 as described above, the clarity of the video image can be improved.

Next, the state illustrated in FIG. 4A is assumed to change to the state illustrated in FIG. 5A. In the state of FIG. 5A, only the participant 50A is speaking. Further, noise is being created at the side of the participant 50E.

In the state illustrated in FIG. 5A, the video conference terminal 100 sets the sound collection range 60 to a range including the participant 50A who is speaking. Further, the video conference terminal 100 matches the view angle 70 with the sound collection range 60. Note that the noise created at the side of the participant 50E does not affect the setting of the sound collection range 60 because the microphone array 18 can distinguish the noise from the speech of the participant 50A.

Therefore, as illustrated in FIG. 5B, the speaking participant 50A and the participant 50B positioned next to the speaking participant 50A are included in the video image extracted by the CCD video camera 16. The video image of FIG. 5B is displayed in the display 40 of each of the other video conference terminals 100 communicating with the video conference terminal 100 of FIG. 5A.

Because the range including the speaking participant 50A is set to be the sound collection range 60 and the view angle 70 is matched with the sound collection range 60 as described above, the clarity of the video image can be improved. Further, in a case where only the participant 50C is speaking, the sound collection range 60 may be set to include only the participant 50C, and the view angle may be matched with the sound collection range 60 that only includes the speaking participant 50C.

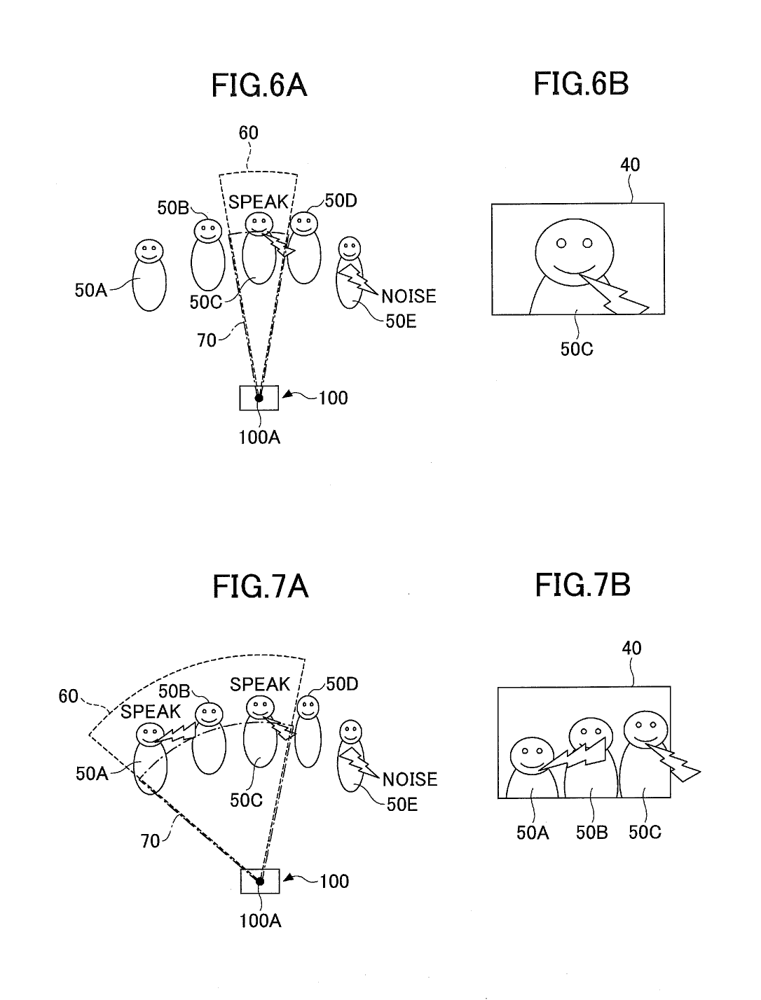

Thus, in the state illustrated in FIG. 6A, the video conference terminal 100 sets the sound collection range 60 to a range that only includes the participant 50C speaking. Further, the video conference terminal 100 matches the view angle 70 with the sound collection range 60.

Therefore, as illustrated in FIG. 6B, only the speaking participant 50C is included in the video image extracted by the CCD video camera 16. The video image of FIG. 63 is displayed in the display 40 of each of the other video conference terminals 100 communicating with the video conference terminal 100 of FIG. 6A.

Because the range including only the speaking participant 50C is set to be the sound collection range 60 and the view angle 70 is matched with the sound collection range 60 as described above, the clarity of the video image can be improved.

Next, the operations of the video conference terminal 100 according to another embodiment of the present disclosure are described with reference to FIGS. 7A and 7B. The state illustrated in, for example, FIG. 4A is assumed to change to the state illustrated in FIG. 7A. In the state of FIG. 7A, the participant 50A and the participant 50C are speaking. Further, noise is being created at the side of the participant 50E.

In the state illustrated in FIG. 7A, the video conference terminal 100 sets the sound collection range 60 to a range including the participant 50A and the participant 50C who are speaking. Further, the video conference terminal 100 matches the view angle 70 with the sound collection range 60. Note that the noise created at the side of the participant 50E does not affect the setting of the sound collection range 60 because the microphone array 18 can distinguish the speech of the participant 50A and the speech of the participant 50C.

Therefore, as illustrated in FIG. 7B, the speaking participant 50A and the speaking participant 500 (having the participant 50B in the middle) are included in the video image extracted by the CCD video camera 16. The video image of FIG. 7B is displayed in the display 40 of each of the other video conference terminals 100 communicating with the video conference terminal 100 of FIG. 7A.

Because the range including the speaking participant 50A and the speaking participant 50C are set to be the sound collection range 60 and the view angle 70 is matched with the sound collection range 60 as described above, the clarity of the video image can be improved.

The sound collection range 60 including the two participants 50A, 500 and the view angle 70 corresponding to the sound collection range 60 cover a broader range compared to the sound collection range 60 and the view angle 70 of FIG. 4A in which only the participant 50C is speaking. Further, the sound collection range 60 including the two participants 50A, 500 and the view angle 70 corresponding to the sound collection range 60 cover a broader range compared to the sound collection range 60 and the view angle 70 of FIG. 5A in which only the participant 50A is speaking.

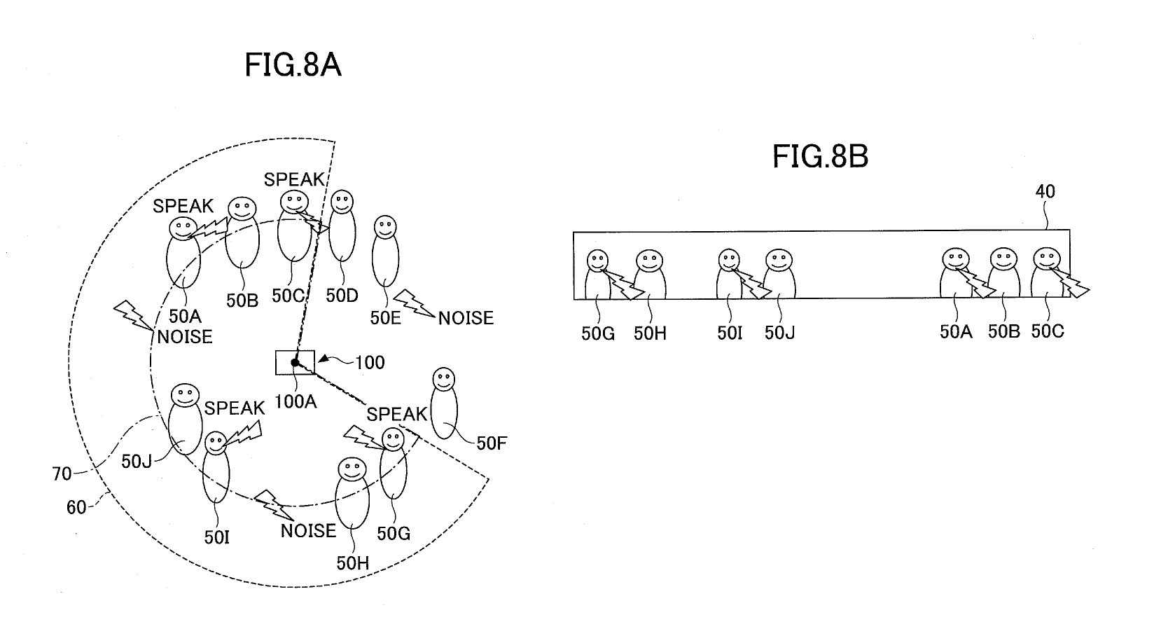

Next, the operations of the video conference terminal 100 according to another embodiment of the present disclosure are described with reference to FIGS. 8A and 8B. FIGS. 8A and 8B illustrate a case where the view angle of the CCD video camera 16 is increased to 360 degrees. The view angle of 360 degrees may be realized by using multiple video cameras that form shot ranges arranged next to each other and stiching the images captured by the multiple video cameras by image processing the images. This image is referred to as a panorama image.

As illustrated in FIG. 8A, participants 50F, 50G, 50H, 50I, and 50J (hereinafter referred to as “50F to 50J”) also use the video conference terminal 100 in addition to the participants 50A to 50E. The participants 50A to 50E and the participants 50F to 50J are facing toward the CCD video camera 16 and sitting in front of the video conference terminal 100.

Among the participants 50A to 50E and the participants 50F to 50J, four participant 50A, 50C, 50G, and 50I are speaking. Further, noise is being created at the side of the participant 50E.

In the state illustrated in FIG. 8A, the video conference terminal 100 sets the sound collection range 60 to a range including the participants 50A, 50C, 50G, and 50I who are speaking. Further, the video conference terminal 100 matches the view angle 70 with the sound collection range 60. Note that the noise created at the side of the participant 50E does not affect the setting of the sound collection range 60 because the microphone array 18 can distinguish the noise from the speech of the participants 50A, 50C, 50G, and 50I.

Therefore, as illustrated in FIG. 8B, the participants 50A, 50C, 50G, and 50I are included in the video image extracted by the CCD video camera 16. The video image of FIG. 8B is displayed in the display 40 of each of the other video conference terminals 100 communicating with the video conference terminal 100 of FIG. 8A.

Because the range including the speaking participants 50A, 50C, 50G, and 50I is set to be the sound collection range 60 and the view angle 70 is matched with the sound collection range 60 as described above, the clarity of the video image can be improved.

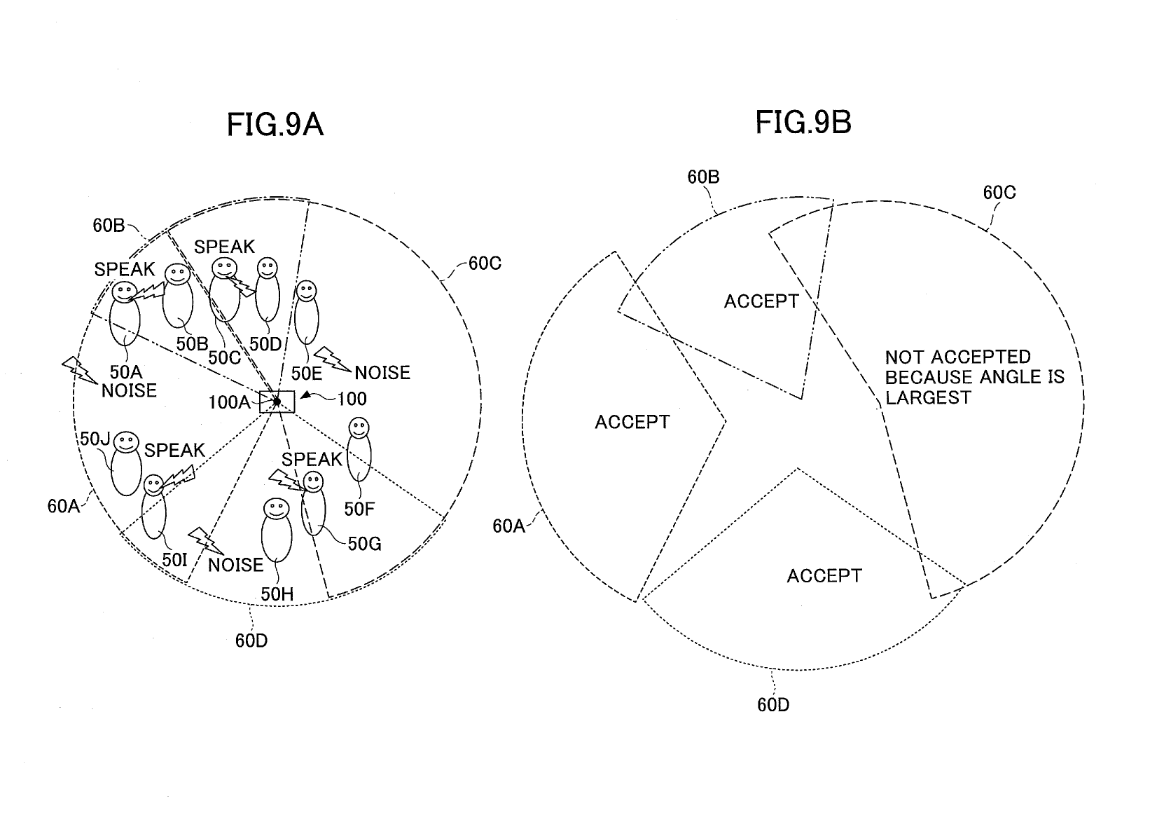

Alternatively, the sound collection range of FIG. 8A may be set as illustrated in FIG. 9A.

In a case where the participants 50A, 50C, 50G, and 50I are speaking in a state where the participants 50A to 50E and the participants 50F to 50J surround the video conference terminal 100 as illustrated in FIG. 9A, sound collection ranges 60A, 60B, 60C, and 60D may be set.

Each of the sound collection ranges 60A, 60B, 60C, and 60D is a sound collection range that is set to include two adjacently positioned participants among the participants 50A, 50C, 50G, and 50I who are speaking. More specifically, the sound collection range 60A includes the participant 50I and the participant 50A, the sound collection range 60B includes the participant 50A and the participant 50C, the sound collection range 60C includes the participant 50C and the participant 50G, and the sound collection range 60D includes the participant 50G and the participant 50I.

FIG. 9B illustrates the sound collection ranges 60A to 60D being extracted and spaced apart from each other. The sound collection range 60C is broadest (largest central angle) among the sound collection ranges 60A to 60D.

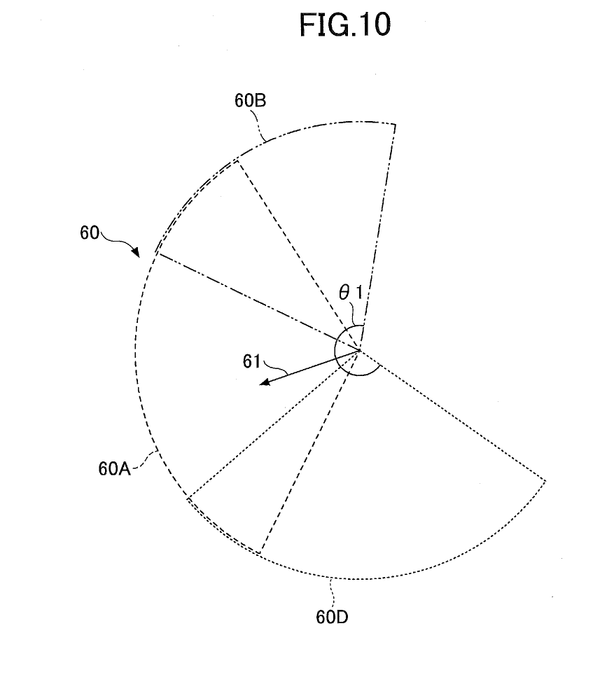

In this case, the video conference terminal 100 excludes the broadest sound collection range 60C and composites the remaining sound collection ranges 60A, 60B, and 60D. Thereby, the video conference terminal 100 obtains a composited sound collection range 60 as illustrated in FIG. 10. The sound collection range 60 illustrated in FIG. 10 is the same as the sound collection range 60 illustrated in FIG. 8A.

In this case, the direction of the microphone array 18 may be directed to the center of the sound collection range 60 having a central angle of θ1 (center direction) as illustrated with an arrow 61 of FIG. 10. The center direction is a direction that equally divides the central angle θ1. Further, the view angle of the CCD video camera 16 may be set in a manner that the center of the view angle of the CCD video camera 16 is directed to the center direction.

The collection range illustrated in FIGS. 9B and 10 may be obtained in the following manner.

In a case where the number of speech directions counted by the counting unit 120 is N or more (N≧integer of 3), N sound collection ranges, each being formed by two adjacent speech directions, are obtained from the N or more speech directions.

The example illustrated in FIG. 9A corresponds to a case where N=4. In this case, four sound collection ranges 60A, 60B, 60C, and 60D are obtained in which two adjacent participants among the speaking participants 50A, 50C, 50G, and 50I are included in the obtained sound collection ranges 60A, 60B, 60C, and 60D.

Once N sound collection ranges are obtained, a composited sound collection range obtained by compositing the sound collection ranges excluding the broadest sound collection range among the N collection ranges (N−1) may be set to be a wide-area sound collection range.

The process of excluding the sound collection range 60C having the broadest central angle among the sound collection ranges 60A-60D and compositing the remaining sound collection ranges 60A, 60B, and 60D corresponds to the process of obtaining the sound collection range illustrated in FIG. 1.

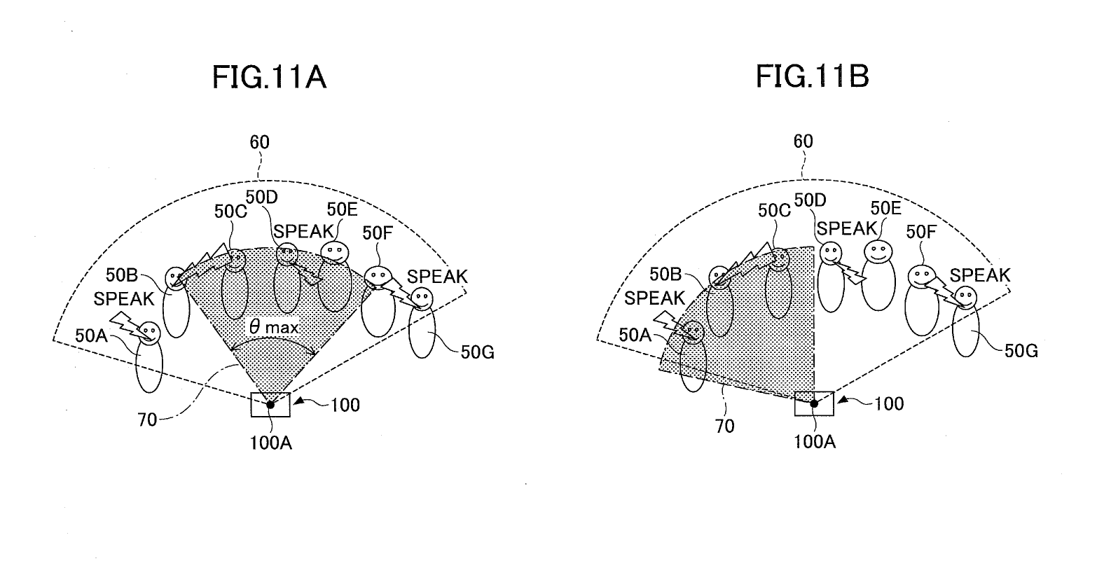

Next, the operations of the video conference terminal 100 according to another embodiment of the present disclosure are described with reference to FIGS. 11A and 11B. As illustrated in FIG. 11A, participants 50A to 50G are using the video conference terminal 100. Participants 50A to 50G, sitting in front of the video conference terminal 100, face the CCD video camera 16.

In the example of FIG. 11A, participants 50A to 50G are speaking. Further, the sound collection range 60 is wider than the maximum view angle θmax of the CCD video camera 16.

In the state illustrated in FIG. 11A, the video conference terminal 100 sets the sound collection range 60 to a range including participants 50A, 50B, 50D, and 50G who are speaking. Further, the video conference terminal 100 sets the view angle 70 to be the maximum view angle θmax.

Further, in the example of FIGS. 11A and 11B, participant 50B has the largest (loudest) voice among the participants 50A, 50B, 50D, and 50G.

In this case, the video conference terminal 100 sets the direction of the maximum view angle θ in a manner that the participant 50B having the largest voice is set to be the center of the maximum field angle as illustrated in FIG. 11B.

Therefore, even in a case where the sound collection range 60 is larger than the maximum view angle θmax of the CCD video camera 16, the sound data of the speeches of all of the speaking participants can be collected. Further, even in a case where the sound collection range 60 is larger than the maximum view angle θmax of the CCD video camera 16, the participant 50B having the largest voice can be included in the video image obtained by the CCD video camera 16.

Because the range including the speaking participants is set to be the sound collection range 60 and the view angle 70 is matched with the sound collection range 60 as described above, the clarity of the video image can be improved.

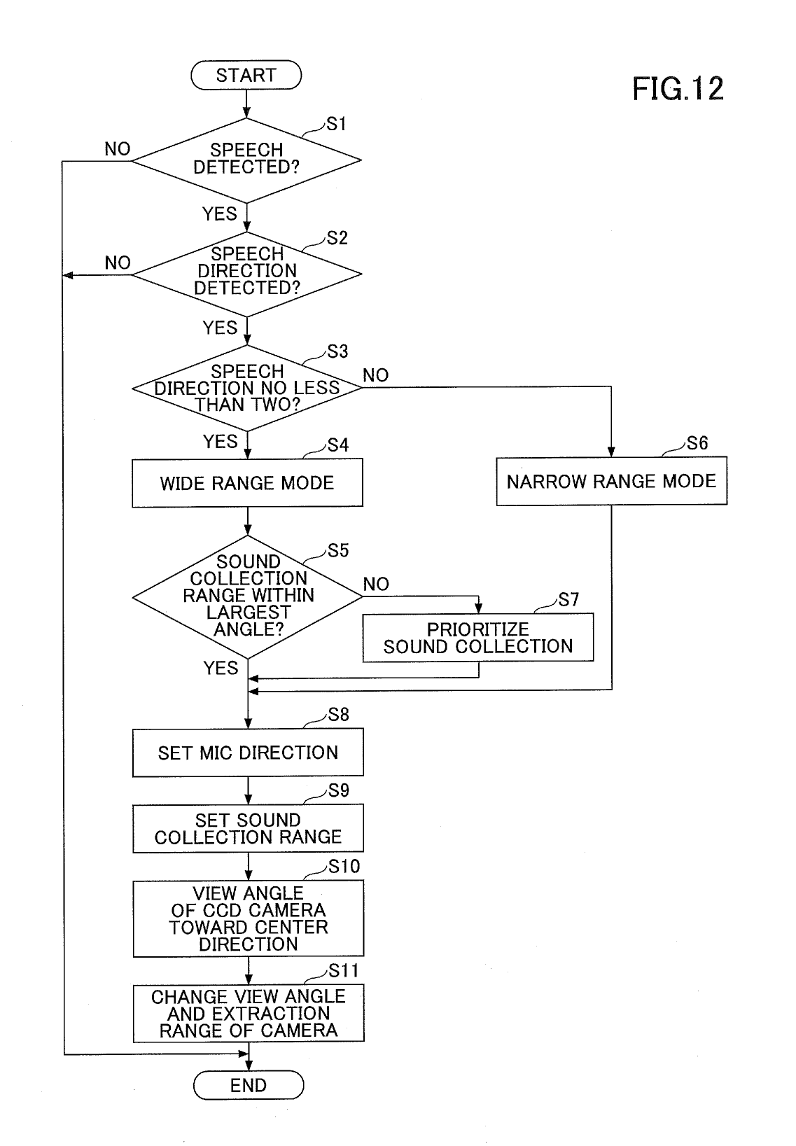

FIG. 12 is a flowchart illustrating an operation performed when the video conference terminal 100 performs the setting of the sound collection range and the view angle according to an embodiment of the present disclosure. The operation performed in FIG. 12 is executed by the main control unit 110, the counting unit 120, the sound collection range setting unit 130, and the view angle setting unit 140 that are included in the CPU 10.

First, the main control unit 110 starts the operation of FIG. 12 when the electric power of the video conference terminal 100 is turned on and a mode for conducting a video conference is selected.

The main control unit 110 determines whether a speech is detected (Step S1). The main control unit 110 determines the detection of a speech by determining whether speech data is input from the microphone array 18.

When the main control unit 110 determines that speech is detected (Yes in Step S1), the main control unit 110 determines whether a speech direction of the speech is detected (Step S2). The main control unit 110 determines the detection of the speech direction by determining whether direction data is input from the microphone array 18.

When the main control unit 110 determines that a speech direction is detected (Yes in Step S2), the counting unit 120 determines whether the number of speech directions is two or more (Step S3). That is, the counting unit 120 determines whether there are speech directions is multiple.

The counting unit 120 determines whether the number of speech directions is two or more by counting the number of speech directions during a predetermined unit period and referring to a value of the number of speech directions counted (count value). The predetermined unit period may be, for example, one second.

When the counting unit 120 determines that the number of speech directions is two or more (Yes in Step S3), the sound collection range setting unit 130 executes a wide range mode (Step S4).

In Step S4, the sound collection range setting unit 130 performs an arithmetic process to obtain a sound collection range that includes the multiple speech directions relative to the reference point 100A. Thereby, the sound collection range setting unit 130 obtains a sector-shaped (fan-shaped) sound collection range covering the range of all of the speech directions as the sound collection range 60 illustrated in FIGS. 7A and 8A.

Then, the sound collection range setting unit 130 determines whether the sound collection range obtained in Step S4 is within the maximum view angle of the CCD video camera 16 (Step S5). The data indicating the maximum view angle may be stored beforehand in the ROM 11. The maximum view angle is determined according to, for example, the unit type of the CCD video camera 16.

Note that, in a case where the counting unit 120 determines that the number of speech directions is not two or more (No in Step S3), the sound collection range setting unit 130 executes a narrow range mode (Step S6). In this case, the speech direction is a single direction.

In Step S6, the sound collection range setting unit 130 obtains a narrow sound collection range for a single person. The data indicating the narrow sound collection range for a single person may be stored beforehand in the ROM 11 and may be read out by the sound collection range setting unit 130. Thereby, the sound collection range setting unit 130 obtains a sector-shaped sound collection range covering the range of the speech directions of the single speaking participant as the sound collection range 60 illustrated in FIG. 6A.

It is, however, to be noted that the sound collection range setting unit 130 may set the sound collection range to include multiple participants as illustrated in FIGS. 4A and 5A in which the single speaking participant is positioned in the center of the sound collection range.

Further, in a case where the sound collection range setting unit 130 determines that the sound collection range obtained in Step S4 is not within the maximum view angle of the CCD video camera 16 (No in Step S5), the sound collection range setting unit 130 executes a process of prioritizing sound collection (sound collection prioritization process) (Step S7).

In the sound collection prioritization process, the sound collection range setting unit 130 sets a range including, for example, the speaking participants 50A, 50B, 50D, and 50G to be the sound collection range 60 and sets the maximum view angle θ max to be the view angle 70.

In Step S7, the sound collection range setting unit 130 sets the sound collection range to include multiple participants. Further, the sound collection range setting unit 130 instructs the view angle setting unit 140 to obtain the center direction, so that the participant having the largest voice is positioned in the center of the view angle 70. Further, the sound collection range setting unit 130 instructs the view angle setting unit 140 to prepare data for setting the view angle 70 to the maximum view angle θmax.

When the sound collection range setting unit 130 completes the processes of Steps S5, S6, or S7, the operation of FIG. 12 proceeds to Step S8. In Step S8, the sound collection range setting unit 130 sets the directivity of the microphone array 18.

In a case where the operation proceeds to Step S8 after the sound collection range is determined to be within the maximum view angle of the CCD video camera 16 (Yes in Step S5), the sound collection range setting unit 130 sets the directivity of the microphone array 18 to be directed to the center direction of the sound collection range obtained in Step S4.

Further, in a case where the operation proceeds to Step S8 after the narrow range mode is executed in Step S6, the sound collection range setting unit 130 sets the directivity of the microphone array 18 to be directed to the center direction of the sound collection range obtained in Step S6.

Further, in a case where the operation proceeds to Step S8 after the sound range prioritization process of Step S7, the sound collection range setting unit 130 sets the directivity of the microphone array 18 to be directed to the center direction of the sound collection range obtained in Step S7.

Then, the sound collection range setting unit 130 sets the sound collection range of the microphone array 18 (Step S9).

In a case where the operation proceeds to Step S9 after the sound collection range is within the maximum view angle of the CCD video camera 16 (Yes in Step S5), the sound collection range setting unit 130 sets the sound collection range of the microphone array 18 to be the sound collection range obtained in Step S4. More specifically, the sound collection range setting unit 130 sets the sound collection range of the beam-forming method of the microphone array 18 to be the sound collection range obtained in Step S4.

Further, in a case where the operation proceeds to Step S9 after the execution of the narrow range mode of Step S6, the sound collection range setting unit 130 sets the directivity of the microphone array 18 to be the sound collection range obtained in Step S6.

Further, in a case where the operation proceeds to Step S9 after the execution of the sound collection prioritization process of Step S7, the sound collection range setting unit 130 sets the directivity of the microphone array 18 to be the sound collection range obtained in Step S7.

Then, the view angle setting unit 140 sets the direction of the view angle of the CCD video camera 16 to the center direction (Step S10). The center direction is, for example, the direction illustrated with the arrow 61 in FIG. 10.

In a case where the operation proceeds to Step S10 after determining that the sound collection range is within the maximum view angle of the CCD video camera 16 (Yes in Step S5), the view angle setting unit 140 sets the direction of the center of the view angle of the CCD video camera 16 to be the center direction of the sound collection range obtained in Step S4.

Further, in a case where the operation proceeds to Step S10 after the execution of the narrow range mode of Step S6, the view angle setting unit 140 sets the direction of the center of the view angle of the CCD video camera 16 to be the center direction of the sound collection range obtained in Step S6.

Further, in a case where the operation proceeds to Step S10 after the execution of the sound collection range prioritization process of Step S7, the view angle setting unit 140 sets the direction of the center of the view angle of the CCD video camera 16 to be the center direction of the sound collection range obtained in Step S7.

Then, the view angle setting unit 140 sets the view angle of the CCD video camera 16 according to the sound collection range (Step S11).

In a case where the operation proceeds to Step S11 after determining that the sound collection range is within the maximum view angle of the CCD video camera 16 (Yes in Step S5), the view angle setting unit 140 sets the view angle of the CCD video camera 16 to match the sound collection range.

As a result, the view angle setting unit 140 cuts out (extract) a part of the video image shot by the CCD video camera 16. The extracted video image includes the multiple participants that are speaking.

Further, in a case where the operation proceeds to Step S11 after the execution of the narrow range mode of Step S6, the view angle setting unit 140 sets the view angle of the CCD video camera 16 to match the sound collection range.

As a result, the view angle setting unit 140 cuts out (extract) a part of the video image shot by the CCD video camera 16. The extracted video image includes the single participant that is speaking.

Further, in a case where the operation proceeds to Step S11 after the execution of the sound range prioritization process of Step S7, the view angle setting unit 140 sets the view angle of the CCD video camera 16 to be the maximum view angle.

In this case, the view angle (maximum view angle) is narrower than the sound collection range. Therefore, the video image that is obtained in this case is an image that includes the participant having the largest voice among the multiple participants that are speaking. Note that, in this case, a video image is not extracted because the view angle (maximum view angle) is narrower than the sound collection range. Therefore, in this case, the entire video image obtained by the maximum view angle is displayed on each display 40 of the other video conference terminals 100.

By performing the process of Step S11, the video image to be displayed on the display 40 is obtained.

Hence, the video conference terminal 100 according to the above-described embodiments can obtain speech data of a speaking participant and video image data of a view angle matching the sound collection range.

With the video conference terminal 100 according to the above-described embodiments, the sound collection range for obtaining speech data is matched with the view angle for obtaining the video image data. Further, the sound collection range is set to include the speaking participant and reduce a range outside (beyond) the range of the speaking participant. Therefore, the collection of sounds other than the speech of the participant included in the video image (undesired sound) can be prevented.

Thus, with the video conference terminal 100 according to the above-described embodiments, the clarity of a sound-attached video image can be improved.

Further, because the view angle is set to the maximum view angle of the CCD video camera 16 and the participant having the largest voice among the speaking participants is included in the video image, a main relevant speech among the speeches of the speaking participants can be transmitted.

Thus, with the video conference terminal 100 according to the above-described embodiments, the clarity of a sound-attached video image can be improved.

The present disclosure is not limited to the specifically disclosed embodiments, and variations and modifications may be made without departing from the scope of the present disclosure.

What is claimed is:

1. A video conference terminal comprising:
a camera that captures a video image of a speaker;
a microphone array that collects a speech of the speaker; and
a processor that executes a process including
determining a direction of the speech,
setting a sound collection range in which the microphone array collects the speech, the sound collection range including a predetermined range that covers the direction of the speech, and
setting a view angle of the camera to match the sound collection range.

2. The video conference terminal as claimed in claim 1, wherein the process of the processor further includes
counting the direction of the speech, and
setting, in a case where a single direction is counted, the sound collection range to be a sound collection range for a single speaker and setting the view angle of the camera to be a view angle matching the sound collection range for the single speaker.

3. The video conference terminal as claimed in claim 1, wherein the process of the processor further includes
counting the direction of the speech, and
setting, in a case where a plurality of directions is counted, the sound collection range to be a wide sound collection range for a plurality of speakers and setting the view angle of the camera to be a wide view angle matching the wide sound collection range.

4. The video conference terminal as claimed in claim 3, wherein in a case where all of the plurality of directions are determined to be within a maximum view angle of the camera, the processor is configured to set the sound collection range to be a wide sound collection range for the plurality of speakers and set the view angle of the camera to be a wide view angle matching the wide sound collection range.

5. The video conference terminal as claimed in claim 3,
wherein the camera includes a plurality of camera units that form shot ranges arranged next to each other, and
wherein the wide view angle includes a view angle formed by compositing each of the view angles of the plurality of camera units.

6. The video conference terminal as claimed in claim 3,
wherein the camera includes a panorama camera that captures a panorama video image, and
wherein the wide view angle includes a view angle that enables the panorama video image to be shot.

7. The video conference terminal as claimed in claim 3, wherein the process of the processor further includes
setting, in a case where the number of directions counted is N (N being an integer equal to or greater than 3), the sound collection range to be a composited sound collection range, and
setting the composited sound collection range by performing a process of
obtaining N sound collection ranges each of which being formed by two adjacent directions among the plurality of directions, and
compositing N−1 sound collection ranges exclusive of a sound collection images having a broadest range among the N sound collection ranges.

8. The video conference terminal as claimed in claim 1, wherein the process of the processor further includes
counting the direction of the speech,
determining, in a case where a plurality of directions is counted, whether an angle including all of the plurality of directions is within a maximum view angle of the camera, and
setting, in a case where the processor determines that the angle including all of the plurality of directions is not within the maximum view angle of the camera, the sound collection range to be a range including all of the plurality of directions and setting the view angle of the camera to be the maximum view angle of the camera.
